(19) United States
(12) Patent Application Publication
(10) Pub. No.: US 2012/0263561 A1
(43) Pub. Date: Oct. 18, 2012

(54) Hydraulic driven ladder rack system

(76) Inventor: Zhengxin Li, St. Louis, MO (US)

(21) Appl. No.: 13/088,588

(22) Filed: Apr. 18, 2011

(51) Int. Cl. B60P 1/32; B60R 9/042

(52) U.S. Cl. 414/462

(57) ABSTRACT

In order to unload/reload ladders from/onto a vehicle's roof without physical power needed, a hydraulic driven ladder rack system has been designed which includes: a chassis mounted on vehicle's roof; a hydraulic driver and a pivotal arm are pivotally coupled on front and rear end of chassis separately. a movable ladder rack engaged with two rolls which installed on top of rear ladder rack supporter; pivotal arm pivotally coupled to front area of ladder rack, hydraulic shaft pivotally coupled to middle of pivotal arm. When hydraulic shaft push out, pivotal arm pivots up and push ladder rack moving upward and backward, until ladder rack arrived generally vertical position in back of vehicle. At this position ladders unload/reload, from/onto ladder rack. When hydraulic shaft draw back, pivotal arm pulls back ladder rack to horizontal position on vehicle's roof. These operations are completed automatically.

### CROSS-REFERENCE TO RELATED APPLICATIONS

U.S. Patent Documents

| | | | |
|---|---|---|---|
| 6,764,268 B2 | July 2004 | Levi | 414/462 |
| 7,097,409 B2 | August 2006 | Richter | 414/462 |

### TECHNICAL FIELD

The present invention relates to device for loading and unloading ladders onto/from ladder rack mounted on vehicles. More particularly, the present invention is directed to ladder rack that is driven by hydraulic and can be moved between storage and loading/unloading position automatically. There is no physical power needed at all.

### BACKGROUND OF THE INVENTION

Many kinds of ladders and other large pieces of equipment, and many tools and materials are required for work, so the big trucks are used more and more. Loading and unloading ladders and other equipments to and form the roof-mounted rack of a vehicle is a difficult and dangerous process.

Numerous ladder racks have been designed to solve these problems. But such ladder racks still apply manually operative mechanism so these ladder racks can't bear more ladders or other equipments and operative altitude is not exceed the height that can be reached by hands of a people who operates the ladder rack standing on the ground. Considering the elevation of the truck, these ladder racks are difficult to be used on a truck.

A need exists for a ladder rack that can bear more ladders and other equipments, can be used on tall truck and no physical power needed to operate.

### BRIEF SUMMARY OF THE INVENTION

The present invention provides a hydraulic driven ladder rack which can move between a horizontal position on vehicle's roof as well as stowage position and a generally vertical position behind the vehicle as well as a loading/uploading position driven by hydraulic. The ladder rack including:

a chassis which is mounted on the roof of vehicle; it has two pivots, front and rear pivots;

a hydraulic driver (hydraulic cylinder and hydraulic driving shafts) that is pivotally coupled to the front pivot of the chassis;

a pivotal arm which has three pivots; up end, middle and low end pivots, the low end pivot is pivotally coupled to the rear end pivot of the chassis;

a pair of rear end ladder rack supporter assembly which are fixed on left and right side of rear area of vehicle's roof; a roll is on top of each supporter;

a movable ladder rack is sliding engaged with the two rolls of the rear end ladder rack supporter;

a fixed ladder rack supporter is fixed on front end of the vehicle's roof.

According to the present invention, the processes of unloading a ladder from the top of a vehicle as follow: In the stowage position, ladder rack is in horizontal on top of the vehicle. When the hydraulic driving shaft push out, the pivotal arm pivots upward, the front end of movable ladder rack is lift up and pushed backward, the ladder rack sliding backward and downward on the rolls of rear end ladder rack supporter till arriving the generally vertical position behind the vehicle in which ladders can be unloaded from the ladder rack.

Reloading is an optical process, when the hydraulic driving shaft draw back, the movable arm is pulled back; the ladder rack is pulled by the movable arm sliding upward and forward on the rolls of rear end ladder rack supporter till arrived the horizontal position on vehicle's roof and set on the front ladder rack supporter, in this position the ladders can be stored and transported.

The processes of unload or reload are automatically. In present invention, the width of ladder rack is as wide as the vehicle so many ladders and other equipments can be loaded on it and it is driven by hydraulic, not by hands, so that ladder rack can reach the elevation of a truck's roof. The process of loading ladders onto or unloading ladders from the roof of a truck is no physical power needed.

### DESCRIPTION OF THE DRAWINGS

FIGS. 1A through 1E are side views of a truck illustrate a sequence in moving the ladder rack of present invention from horizontal position on vehicle's roof to generally vertical position behind the vehicle and an opposite process moving the ladder rack back on top of the vehicle to horizontal position.

1A ladder rack of present invention is on top of the vehicle in a horizontal position that is the stowage position.

1B the ladder rack is lifted up by pivotal arm, sliding backward and downward.

1C the ladder rack is in the generally vertical position behind the vehicle that is loading/unloading position.

1D in an opposite process the ladder rack is pulled by pivot arm, sliding upward and forward.

1E the ladder rack is in the horizontal position on the top of the vehicle.

FIG. 2 is a rear perspective view of a truck on which the ladder rack system according to one embodiment of the present invention is installed with a 12-foot extension ladder, an 8-foot fold ladder and a wheelbarrow mounted thereon and located in generally vertical position behind the truck.

FIG. 3 is a partly section side perspective view of the pivotal arm, hydraulic driver and the front end of the moveable ladder rack assembly with the ladder rack located in generally vertical position.

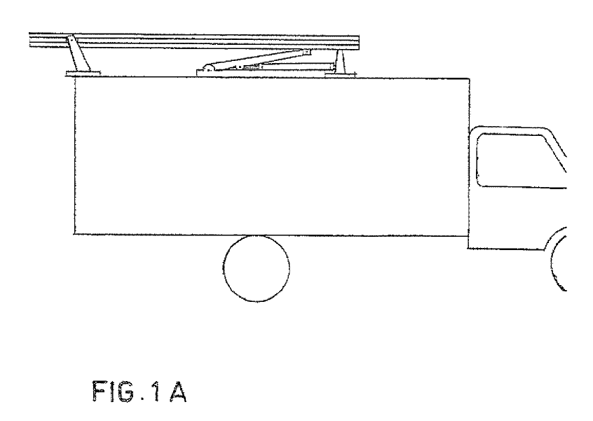

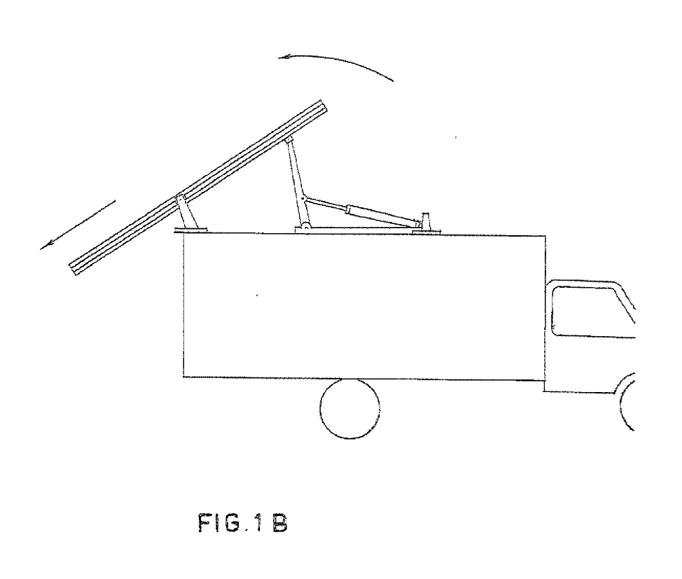

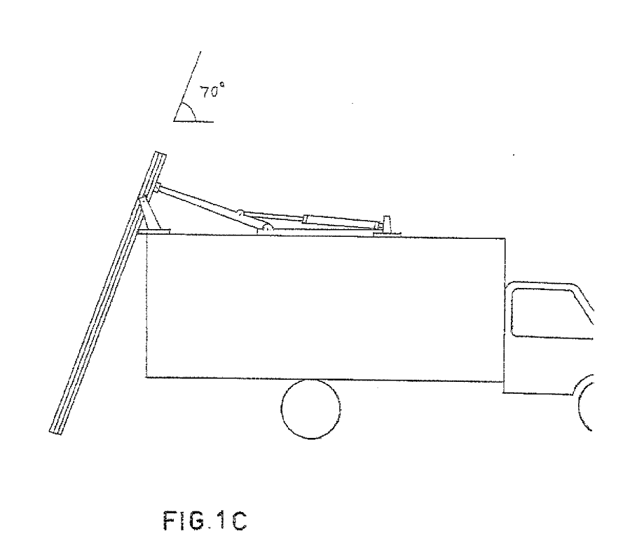

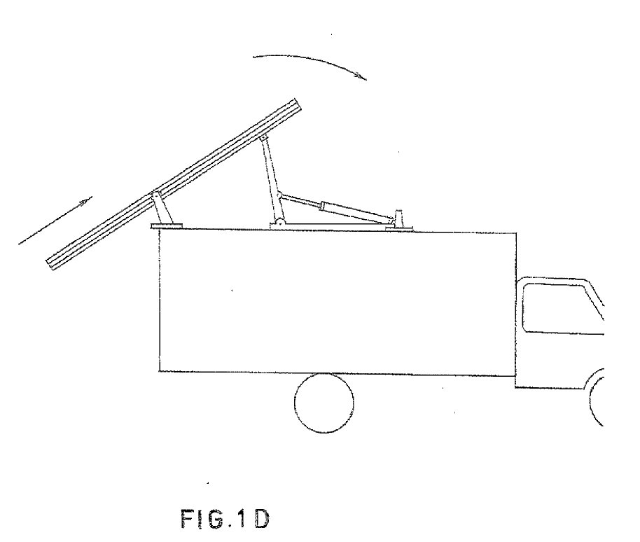

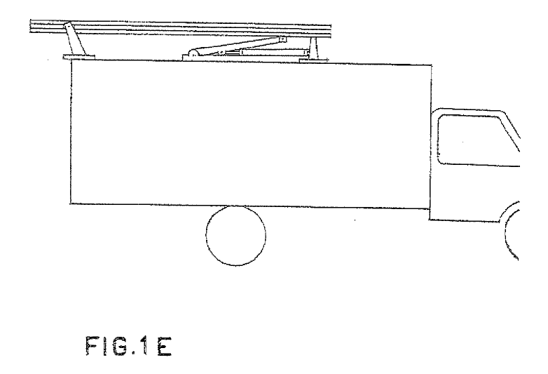

### DESCRIPTION OF THE PREFERRED EMBODIMENT

The present invention provides a ladder rack for loading, unloading and stowage of ladders and other equipments on the rack without manual operation. The ladder rack preferably has a pivotal arm which can move the ladder rack between a horizontal stowage position above a vehicle and a generally vertical loading/unloading position behind a vehicle. The pivotal arm has three pivots: the upper pivot is pivotally coupled to the pivot which fixed on middle of the crossbeam of the movable ladder rack; lower pivot is pivotally coupled to the rear end pivot of the chassis that is fixed on middle of the vehicle roof securely; the middle pivot of pivotal arm is pivotally coupled with the hydraulic driving shaft and the end of hydraulic cylinder is pivotally coupled to the front end pivot of the chassis. A pair rear end ladder rack supporters mounted on rear end both side of vehicle's roof has a roll on top of each supporter. The ladder rack is sliding engaged to these rolls that allowed the ladder rack sliding forward/backward and pivoting upward/downward. Movable ladder rack can moves form horizontal position above a vehicle to a generally vertical position behind a vehicle or reverse.

Although the ladder rack according to the present invention is described here below in reference to a specific use in conjunction with a truck, it is to be understood that this description is presented as a non-limiting example only.

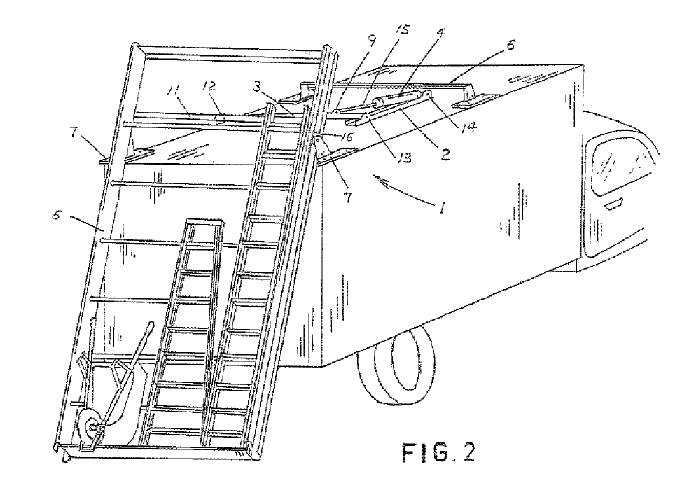

As shown in FIG. 2, there is indicated generally by numeral 1 ladder rack system constructed in accordance with the present invention. It includes:

a chassis 2;
a pivotal arm 3;
a hydraulic driver 4;
a movable ladder rack assembly 5;
a front end ladder rack supporter 6;
a pair rear end ladder rack supporters assembly 7;

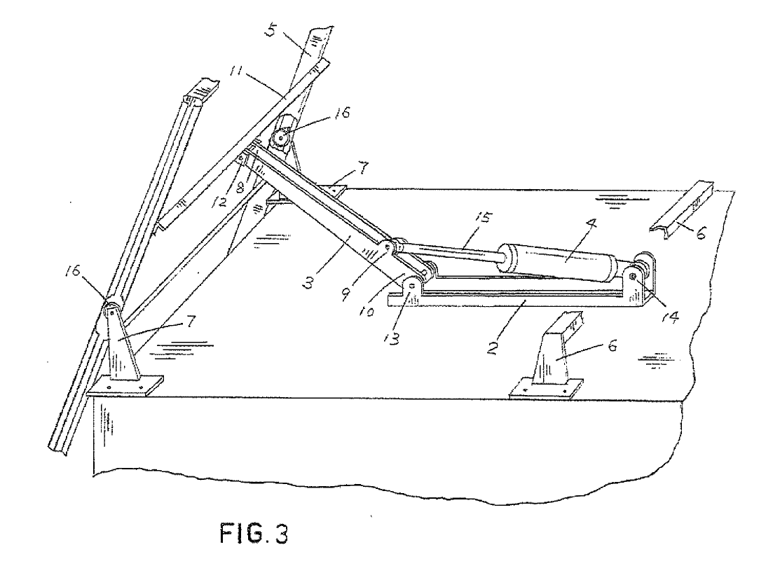

FIG. 3 is a partly section side perspective view of the pivotal arm, hydraulic driver and the front end of the moveable ladder rack assembly with the ladder rack located in generally vertical position. Chassis 2 is a U-shape cross-section metal beam mounted on middle of vehicle's roof and it provides installing construction for pivotal arm 3 and hydraulic driver 4.

The pivotal arm 3 has three pivots: the upper pivot 8; the middle pivot 9; the lower pivot 10; the upper pivot 8 is pivotally coupled to the pivot 12 which fixed on middle of the crossbeam 11 of the movable ladder rack 5; lower pivot 10 is pivotally coupled to the rear end pivot 13 of the chassis 2; the middle pivot 9 of pivotal arm 3 is pivotally coupled with the hydraulic driving shaft 15 and the hydraulic cylinder 4 is pivotally coupled to the front end pivot 14 of the chassis 2.

The ladder rack assembly 5 is a rectangle metal frame, in left and right side it is made of two C-shape cross-section bars which are fixed by two L-shape cross-section bars in front end and rear end. A cross-beam 11 is fixed on upper area of the movable ladder rack 5, there is pivot 12 on middle of the cross-beam 11. Between the two C-shape cross-section bars of the ladder rack 5, there are some rungs on which the ladders and other equipments are installed as shown in FIG. 2.

A pair of rear end ladder rack supporters assembly 7 are mounted separately on rear area left and right side of vehicle's roof. There is a roll 16 fixed on top of each rear end ladder rack supporter 7 and the C shape cross-section bars of the movable ladder rack 5 can slide/pivot on the rolls 16 as shown in FIG. 3.

This invention has been described with reference to particular means and embodiments. Various changes and modifications can be made to carry out the invention. However, it is to be understood that various changes and modifications can be accomplished without departing described above.

What is claimed is:

1. A hydraulic driven ladder rack for moving ladders and other equipments between the stowage position and loading/unloading position without physical power need, said ladder rack comprising:
a chassis mounted on the roof of a vehicle.
a pivotal arm pivotally coupled on the chassis.
a hydraulic driver pivotally coupled between the chassis and pivotal arm.
a movable ladder rack assembly is pivotally coupled to pivotal arm.
a pair of ladder rack supporters assembly on which movable ladder rack can sliding and pivoting freely.
a fixed ladder rack supporter

2. A ladder rack as in claim 1, wherein a chassis provides a support and mounting structure for the hydraulic driver and the pivotal arm.

3. A ladder rack as in claim 1, wherein the pivotal arm has three pivots: upper end; middle; and lower end pivots.

4. A ladder rack as in claim 3, wherein the pivotal arm pivotally coupled to rear end pivot of chassis via the lower end pivot, pivotal arm can pivot with respect to the chassis.

5. A ladder rack as in claim 1, wherein a movable ladder rack is pivotally coupled to the pivotal arm, it can be pushed and pulled by pivotal arm.

6. A ladder rack as in claim 1, wherein a hydraulic driver pivotally coupled between chassis and pivotal arm.

7. A ladder rack as in claim I, wherein a pair of rear end ladder rack supporters assembly mounted on both side of rear area of vehicle's roof.

8. A ladder rack as in claim 7, further comprising two rolls are pivotally mounted on top of rear end ladder rack supporter, one for each.

9. A ladder rack as in claim 1, wherein a movable ladder rack is sliding engaged with said rolls of rear end ladder rack supporter on which the ladder rack can slid and pivot freely.

10. A ladder rack according to claim 9, further comprising a crossing-beam is in upper area of the movable ladder rack and a pivot fixed on middle of the crossing-beam.

11. A ladder rack as in claim 10, wherein said pivot of movable ladder rack is pivotally coupled to the upper end pivot of pivotal arm.

12. A ladder rack as in claim 1, wherein a front end ladder rack supporter is mounted on front area of vehicle's roof, when ladder rack is in horizontal position, ladder rack sits on it.

13. A ladder rack as in claim 1, wherein when the hydraulic driving shaft push out, the pivotal arm pivots upward, the front end of movable ladder rack is lift up and pushed backward, the ladder rack sliding backward and downward on the rolls of rear end ladder rack supporter till arrived the generally vertical position behind the vehicle.

14. A ladder rack as in claim 1, wherein when the hydraulic driving shaft draw back, the pivotal arm is pulled back, the ladder rack is pulled by the pivotal arm sliding upward and forward on the rolls of rear end ladder rack supporter till arrive the horizontal position on vehicle's roof.
